(19) United States
(12) Patent Application Publication
(10) Pub. No.: US 2016/0016472 A1
(43) Pub. Date: Jan. 21, 2016

(54) VEHICLE DISPLAY APPARATUS

(71) Applicant: HONDA MOTOR CO., LTD., Tokyo (JP)

(72) Inventors: Yasuhiro Konishi, Wako-shi (JP); Tetsuya Kawahara, Wako-shi (JP)

(73) Assignee: HONDA MOTOR CO., LTD., Tokyo (JP)

(21) Appl. No.: 14/799,829

(22) Filed: Jul. 15, 2015

(30) Foreign Application Priority Data
Jul. 16, 2014 (JP) 2014-145722

(51) Int. Cl. B60K 37/02; G06T 19/00; G06T 3/60; B60K 35/00; G01D 11/28

(52) U.S. Cl. CPC B60K 37/02; B60K 35/00; G01D 11/28; G06T 3/60; G06T 19/006

(57) ABSTRACT

A vehicle display apparatus includes a left decorative panel and a right decorative panel each including a first instrument panel and a second instrument panel, a left rotating mechanism that rotates the left decorative panel about an axis of rotation and changes which of the first instrument panel and the second instrument panel to be allowed to face toward a driver in a vehicle, and a right rotating mechanism that rotates the right decorative panel about an axis of rotation and changes which of the first instrument panel and the second instrument panel to be allowed to face toward the driver in the vehicle.

### CROSS REFERENCES TO RELATED APPLICATIONS

The present application claims priority under 35 U.S.C. §119 to Japanese Patent Application No. 2014-145722, filed Jul. 16, 2014, entitled “Vehicle Display Apparatus.” The contents of this application are incorporated herein by reference in their entirety.

### BACKGROUND

1. Field

The present disclosure relates to a vehicle display apparatus.

2. Description of the Related Art

In related-art vehicle display apparatuses, pieces of information such as the vehicle speed, the engine speed, and so forth are displayed on disc-shaped instrument members provided with scales, indicators, and so forth. In such a related-art vehicle display apparatus, however, it is difficult to change the positions and/or the colors of the instrument members and/or the arrangement of the scales, leading to poor design. To solve such a problem, a known vehicle display apparatus includes a movable instrument member, thereby being capable of providing a plurality of display states.

For example, Japanese Patent No. 4637546 has disclosed a vehicle display apparatus including a display having a display area in which various pieces of information on the state of a vehicle are displayed, and a first control unit that controls which image is to be displayed on the display. The vehicle display apparatus further includes a display-dividing member (corresponding to “ ” according to the present disclosure) provided on a part of the display area and having an opening that defines a first display area. The first control unit controls the first display area to display an image that represents a display design corresponding to a circular dial with an indicator. The first control unit changes the display design on the basis of a predetermined display-change instruction signal by controlling the image of the display design and the indicator as a whole to rotate such that the relative positions of the display design and the indicator are maintained. The vehicle display apparatus further includes a moving mechanism that moves the display-dividing member. The first control unit moves the image of the display design synchronously with the movement of the display-dividing member.

According to Japanese Patent No. 4637546, the vehicle display apparatus can provide a well-defined, three-dimensional display at low cost and with unprecedented novelty and originality.

In the vehicle display apparatus disclosed by Japanese Patent No. 4637546, however, the display-dividing member is movable only on the display area, and it is not possible to change the display-dividing member itself. Hence, the vehicle display apparatus disclosed by Japanese Patent No. 4637546 still has room for improvement in design.

### SUMMARY

The present application describes a vehicle display apparatus that provides a display with superior design.

According to an aspect of the present application, there is provided a vehicle display apparatus including a decorative panel (for example, each of the decorative panels 30 according to the embodiment described below) provided with a plurality of instrument members as gauges that indicate certain vehicle conditions such as an engine speed, etc. (for example, the first instrument member 36 and the second instrument member 38 according to the embodiment), and a rotating mechanism (for example, each of the rotating mechanisms 35 according to the embodiment) that rotates the decorative panel about a predetermined axis of rotation (for example, each of the axes of rotation P according to the embodiment) and changes which of the plurality of instrument members to be allowed to face toward a driver in a vehicle. As in the embodiment, each of the decorative panels 30 may have a first side and a second, opposite side, and the axis of rotation P may be set along a main plane of the garnish 13 that rotatably supports the decorative panels such that each decorative panel can be rotated upside down so that one side of them is faced to the driver. When one side of each decorative panel is aligned with the front side of a garnish 13, these are faced to a driver to constitute a decorative instrumental panel shown to the driver.

According to the above aspect of the present application, since the vehicle display apparatus includes the rotating mechanism that changes which of the plurality of instrument members to be allowed to face toward the driver in the vehicle, a plurality of instrument members having different shapes are allowed to be viewed by the driver. Thus, a vehicle display apparatus capable of providing a display with superior design is obtained.

The above vehicle display apparatus may further include a light source (for example, each of the light sources 40 according to the embodiment) that illuminates the decorative panel, and a virtual-image-generating unit (for example, the virtual-image-generator 20 according to the embodiment) that displays a virtual image in a space (such as on a screen facing the driver) between the driver in the vehicle and the decorative panel. On the screen, the virtual image is superimposed on an image of the vehicle condition-information generated from the decorative panel so that the driver can recognize the superimposed image.

In the vehicle display apparatus configured in such a case, while one of the instrument members of the decorative panel is made visible to the driver by illuminating the decorative panel with the light source, a virtual image can be displayed in any area by using the virtual-image-generating unit. Hence, the vehicle display apparatus can provide a display with superior design, without losing the texture of the real instrument member, by causing the virtual-image-generating unit to display a virtual image in the space between the driver and the instrument member in such a manner as to superpose the virtual image upon the instrument member.

In the above vehicle display apparatus, the light source may be switchable between an on state and an off state.

In such a case, the instrument member is made visible to the driver when the light source is on. Thus, a display that is superior in expressing the texture of the real instrument member is provided. Furthermore, the instrument member of the decorative panel is not visible to the driver when the light source is off. Therefore, the virtual-image-generating unit can display a virtual image that is free of restrictions imposed by the shape of the instrument member even in an area where, when seen from the driver, the instrument member of the decorative panel is provided.

In the above vehicle display apparatus, the decorative panel may include a first instrument member (for example, the first instrument member 36 according to the embodiment) and a second instrument member (for example, the second instrument member 38 according to the embodiment). Furthermore, by rotating the decorative panel about the axis of rotation, the rotating mechanism may alternate a first state where the first instrument member faces toward the driver and a second state where the second instrument member faces toward the driver. Furthermore, the light source may be off during a transition between the first state and the second state. During the transition between the first state and the second state, the virtual-image-generating unit may display a process in which a shape of the first instrument member in the first state that is viewed by the driver changes continuously and a process in which a shape of the second instrument member in the second state that is viewed by the driver changes continuously. As in the embodiment, a virtual-image-generator displays a plurality of different virtual images in the order such that the plurality of different virtual images constitute step-by-step changes from a shape of the first instrument member in the first state to a shape of the second instrument member in the second state in a manner that allows the driver to view the changes as if the image continuously changes.

In such a case, since the light source is off during the transition between the first state where the first instrument member faces toward the driver and the second state where the second instrument member faces toward the driver, the decorative panel that is being rotated is not visible to the driver. While the decorative panel is being rotated, the virtual-image-generating unit of the vehicle display apparatus displays, as virtual images, the process in which the shape of the first instrument member and the shape of the second instrument member change during the transition. Therefore, the driver views the first instrument member and the second instrument member that are in transition as if they were changing their shapes continuously. Thus, a display with far superior design is provided.

### BRIEF DESCRIPTION OF THE DRAWINGS

FIG. 1 is a perspective view of a vehicle display apparatus according to an embodiment.

FIG. 2 is an exploded perspective view of the vehicle display apparatus according to the embodiment.

FIG. 3 is a perspective view of a right decorative panel seen from a first major-face side thereof.

FIG. 4 is a perspective view of the right decorative panel seen from a second major-face side thereof.

FIG. 5 is a front view illustrating a state of display provided by the vehicle display apparatus.

FIG. 6 is a front view illustrating virtual images alone that are in the state illustrated in FIG. 5.

FIG. 7 is a front view illustrating another state of display provided by the vehicle display apparatus.

FIG. 8 is a front view illustrating virtual images alone that are in the state illustrated in FIG. 7.

FIG. 9 illustrates a state in the transition of the display provided by the vehicle display apparatus and is an enlargement of an area S defined in FIG. 5.

FIG. 10 illustrates another state in the transition of the display provided by the vehicle display apparatus and is an enlargement of the area S defined in FIG. 5.

FIG. 11 illustrates yet another state in the transition of the display provided by the vehicle display apparatus and is an enlargement of the area S defined in FIG. 5.

FIG. 12 illustrates yet another state in the transition of the display provided by the vehicle display apparatus and is an enlargement of the area S defined in FIG. 5.

### DESCRIPTION OF THE PREFERRED EMBODIMENTS

An embodiment of the present application will now be described with reference to the accompanying drawings.

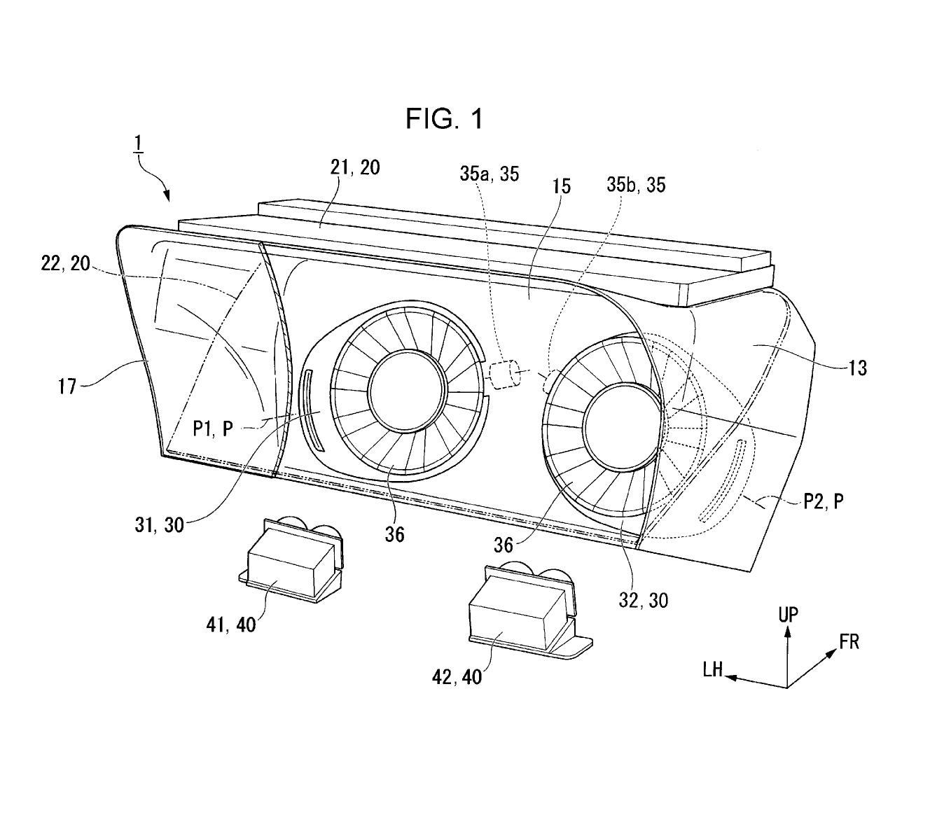

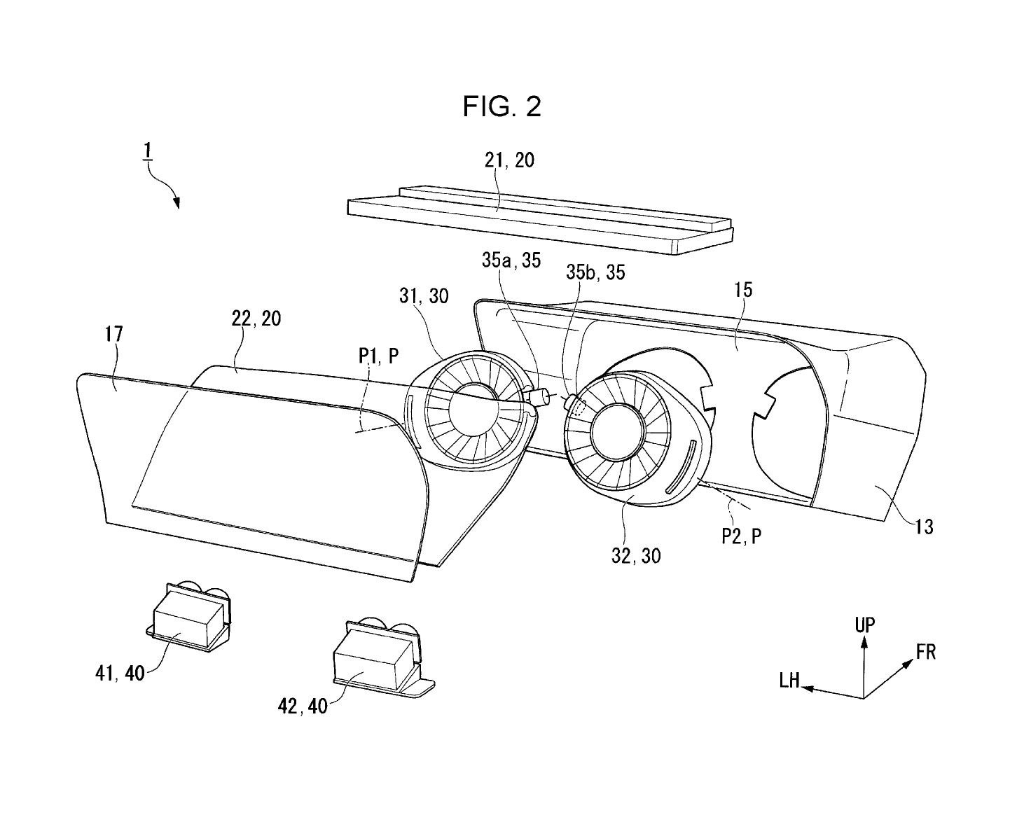

FIG. 1 is a perspective view of a vehicle display apparatus 1 according to an embodiment of the present application. FIG. 2 is an exploded perspective view of the vehicle display apparatus 1.

As illustrated in FIGS. 1 and 2, the vehicle display apparatus 1 according to the embodiment is to be installed on a dashboard in front of a driver's seat of a vehicle and displays vehicle-state information such as the vehicle speed, the engine speed, the fuel level, and so forth. The vehicle display apparatus 1 includes a garnish 13, a pair of decorative panels 30 each provided with a first instrument member 36 and a second instrument member 38 (see FIG. 4), rotating mechanisms 35 (a left rotating mechanism 35a and a right rotating mechanism 35b) that rotate the respective decorative panels 30 about respective axes of rotation P, light sources 40 that illuminate the respective decorative panels 30, and a virtual-image-generator 20 that displays virtual images in a space between a driver in the vehicle and the decorative panels 30. The anteroposterior, vertical, and horizontal directions defined in the following description correspond to the anteroposterior, vertical, and horizontal directions, respectively, of the vehicle, unless otherwise stated. In each of the drawings, an arrow UP points toward the upper side, an arrow FR points toward the front side, and an arrow LH points toward the left side.

As illustrated in FIG. 1, the garnish 13 forms an outer shell of the vehicle display apparatus 1. The garnish 13 has a horizontally long rectangular shape in front view, with the rear side thereof being open. The garnish 13 as a whole is a cylindrical member with a bottom. The inner surface of the garnish 13 has a lower reflectance than the surfaces of the first instrument members 36 and the second instrument members 38 of the decorative panels 30 to be described separately below, and is colored in, for example, black or the like. The bottom of the garnish 13 forms a flat meter face 15. A lens 17 is fitted in and closes the opening of the garnish 13. The garnish 13 also has a rectangular opening at the top thereof. The meter face 15 has a pair of openings in which the pair of decorative panels 30, to be described separately below, are fitted.

The lens 17 is made of an optically transmissive material such as resin, glass, or the like. The lens 17 has a horizontally long rectangular shape in front view and has a curved surface with a vertically central part thereof being convex toward the front side (see FIG. 2). The lens 17 is fitted in the rear opening of the garnish 13 such that the vertically upper end thereof is tilted toward the rear side. Thus, the lens 17 tightly seals the opening of the garnish 13 and prevents dust or the like from entering the inside of the garnish 13. Furthermore, the lens 17 reflects external light toward the lower side, thereby suppressing the entrance of external light into the garnish 13.

The decorative panels 30 include a left decorative panel 31 and a right decorative panel 32. The left decorative panel 31 and the right decorative panel 32 are in plane symmetry with respect to a plane extending through the horizontal center of the garnish 13 and being orthogonal to the horizontal direction. Hence, the following description basically concerns the right decorative panel 32. Accordingly, elements of the left decorative panel 31 that are the same as those of the right decorative panel 32 are denoted by corresponding ones of the reference numerals given to the right decorative panel 32, and description thereof is omitted.

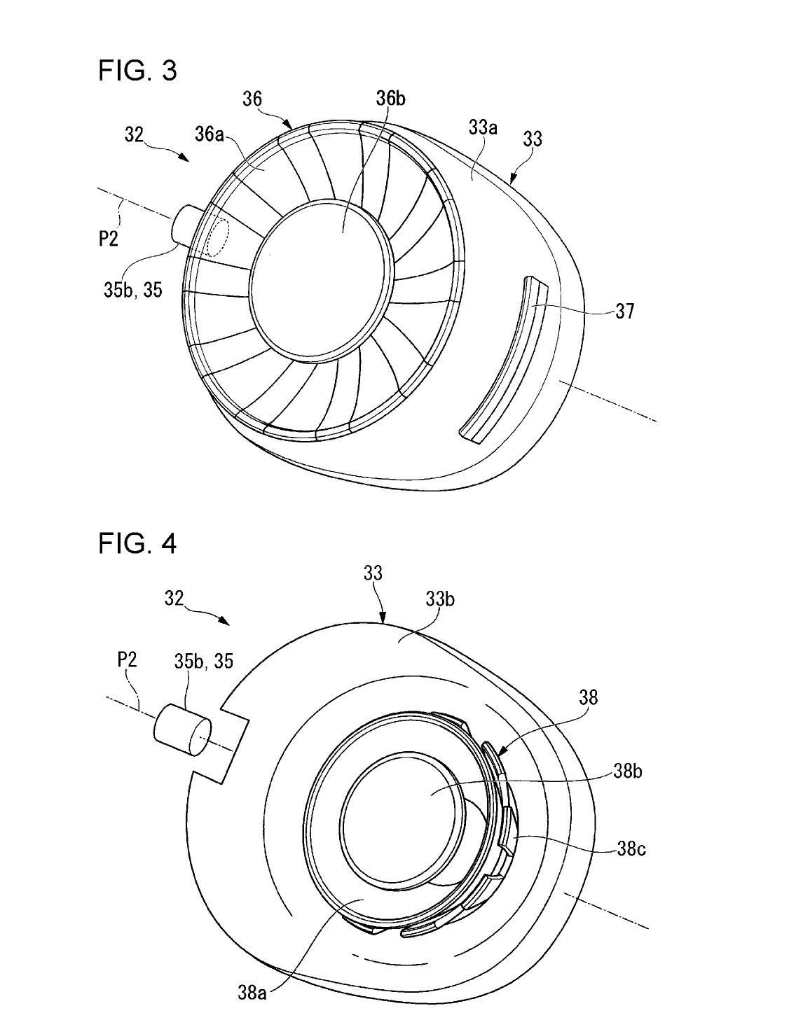

FIG. 3 is a perspective view of the right decorative panel 32 seen from a first major-face side thereof. FIG. 4 is a perspective view of the right decorative panel 32 seen from a second major-face side thereof.

As illustrated in FIGS. 3 and 4, the right decorative panel 32 includes a plate-like base portion 33, the first instrument member 36 provided on a first major face 33a of the base portion 33, an ornamental portion 37 provided on a side of the first instrument member 36, and the second instrument member 38 provided on a second major face 33b of the base portion 33.

The base portion 33 has an oval shape in plan view with one axis of symmetry. The direction of the axis of symmetry in the plan-view shape corresponds to the longitudinal direction of the base portion 33. The base portion 33 is wider on one of the longitudinal side thereof than on the other. The first major face 33a of the base portion 33 is substantially flat. The second major face 33b of the base portion 33 has a smooth depression on the narrower side thereof.

As illustrated in FIG. 3, the first instrument member 36 is provided on the wider side of the first major face 33a of the base portion 33. The first instrument member 36 includes a large-diameter portion 36a having a circular shape in front view, and a small-diameter portion 36b provided in the center of the large-diameter portion 36a. The large-diameter portion 36a is provided on the first major face 33a of the base portion 33 and has a bowl-like shape extending in such a manner as to be gradually spaced apart from the base portion 33 in the radial direction from the center toward the outer side thereof. The small-diameter portion 36b has a disc-like shape with the outside diameter thereof being about half the outside diameter of the large-diameter portion 36a. The small-diameter portion 36b provided in the center of the large-diameter portion 36a is spaced apart from the bottom of the large-diameter portion 36a. A side of the small-diameter portion 36b that faces the base portion 33 may be provided with a light source that illuminates the inner surface of the large-diameter portion 36a.

The ornamental portion 37 stands on the narrower side of the first major face 33a of the base portion 33 and has a curved rectangular plate-like shape. Seen in the thickness direction of the base portion 33, the ornamental portion 37 has an arc shape forming a part of a circle that is concentric with the first instrument member 36. The ornamental portion 37 is illuminated by an ornamental-portion light source (not illustrated) provided on the outer surface of the large-diameter portion 36a of the first instrument member 36.

As illustrated in FIG. 4, the second instrument member 38 is provided on the narrower side of the second major face 33b of the base portion 33. The second instrument member 38 includes a large-diameter portion 38a having a circular shape in front view, a small-diameter portion 38b provided in the center of the large-diameter portion 38a, and a plurality of petal portions 38c provided around the large-diameter portion 38a. The large-diameter portion 38a has a bowl-like shape whose outside diameter is smaller than the outside diameter of the large-diameter portion 36a of the first instrument member 36. The large-diameter portion 38a is provided in the depression of the second major face 33b of the base portion 33 and extends in such a manner as to be gradually spaced apart from the base portion 33 in the radial direction from the center toward the outer side thereof. The small-diameter portion 38b has a disc-like shape with the outside diameter thereof being about half the outside diameter of the large-diameter portion 38a. The small-diameter portion 38b provided in the center of the large-diameter portion 38a is spaced apart from the bottom of the large-diameter portion 38a. A side of the small-diameter portion 38b that faces the base portion 33 may be provided with a light source that illuminates the inner surface of the large-diameter portion 38a. The plurality of petal portions 38c each have a rectangular plate-like shape and stand on the second major face 33b of the base portion 33 at substantially regular intervals along the outer circumference of the large-diameter portion 38a in front view.

As illustrated in FIG. 1, the right decorative panel 32 is fitted in the right one of the openings provided in the meter face 15, with the narrower-side end thereof in the longitudinal direction being oriented toward the lower right. In this state, the right decorative panel 32 is supported by the right rotating mechanism 35b. The right rotating mechanism 35b includes, for example, a motor or the like and rotates the right decorative panel 32 about an axis of rotation P2, thereby changing which of the first instrument member 36 and the second instrument member 38 to be allowed to face toward the driver in the vehicle. The axis of rotation P2 coincides with the axis of symmetry of the base portion 33 of the right decorative panel 32 in plan view when seen in the thickness direction of the base portion 33 of the right decorative panel 32. Hence, the right rotating mechanism 35b is capable of switching the state of display between a first state where the first instrument member 36 faces toward the driver and a second state where the second instrument member 38 faces toward the driver by rotating the right decorative panel 32 about the axis of rotation P2.

The left decorative panel 31 has the same configuration as the right decorative panel 32. The left decorative panel 31 is fitted in the left one of the openings provided in the meter face 15, with the narrower-side end thereof in the longitudinal direction being oriented toward the lower left. In this state, the left decorative panel 31 is supported by the left rotating mechanism 35a. As with the right rotating mechanism 35b, the left rotating mechanism 35a includes, for example, a motor or the like and rotates the left decorative panel 31 about an axis of rotation P1, thereby changing which of the first instrument member 36 and the second instrument member 38 to be allowed to face toward the driver in the vehicle. As with the axis of rotation P2, the axis of rotation P1 coincides with the axis of symmetry of the base portion 33 of the left decorative panel 31 in plan view when seen in the thickness direction of the base portion 33 of the left decorative panel 31. Hence, the left rotating mechanism 35a is capable of switching the state of display between a first state where the first instrument member 36 faces toward the driver and a second state where the second instrument member 38 faces toward the driver by rotating the left decorative panel 31 about the axis of rotation P1.

The light sources 40 include a left light source 41 that illuminates the left decorative panel 31, and a right light source 42 that illuminates the right decorative panel 32. The left light source 41 includes two light sources that illuminate the first instrument member 36 and the second instrument member 38, respectively, of the left decorative panel 31. As with the left light source 41, the right light source 42 includes two light sources that illuminate the first instrument member 36 and the second instrument member 38, respectively, of the right decorative panel 32.

The light sources 40 are provided on the rear side with respect to the decorative panels 30 and below the garnish 13. The left light source 41 and the right light source 42 are arranged side by side in that order from the left side to the right side. The light sources 40 each include, for example, light-emitting diodes or the like and emit highly directive light toward the first and second instrument members 36 and 38 from below the garnish 13. The light sources 40 are connected to a control unit (not illustrated) and are switchable between an on state and an off state. When the decorative panels 30 receive beams of light from the respective light sources 40 that are on, the beams of light are reflected by the respective first instrument members 36 or the respective second instrument members 38, and are viewed as real images by the driver through a half mirror 22, to be described below, and the lens 17.

The virtual-image-generator 20 displays virtual images in the space between the driver in the vehicle and the decorative panels 30. The virtual-image-generator 20 includes an image displaying device 21 and the half mirror 22. In FIG. 1, for easy understanding, the half mirror 22 is illustrated by virtual lines.

The image displaying device 21 may be, for example, a liquid-crystal display device or the like. The image displaying device 21 has a rectangular plate-like shape. The image displaying device 21 is provided in such a manner as to close the top opening of the garnish 13, with an image screen thereof facing toward the inside of the garnish 13 (downward).

The half mirror 22 is optically transmissive and reflective and is obtained by, for example, providing a dielectric layer on a surface of a glass plate. The half mirror 22 has a rectangular plate-like shape and is provided in the garnish 13 in such a manner as to be tilted downward from the front side toward the rear side. The angle of tilt of the half mirror 22 with respect to the vertical direction is set to a value that allows the images displayed by the image displaying device 21 to be reflected by the half mirror 22 and to be visible to the driver. That is, the images displayed by the image displaying device 21 are reflected by the half mirror 22, are transmitted through the lens 17, and are viewed as virtual images by the driver.

Functions of the vehicle display apparatus 1 according to the embodiment will now be described.

First, the first state and the second state of the decorative panels 30 will be described.

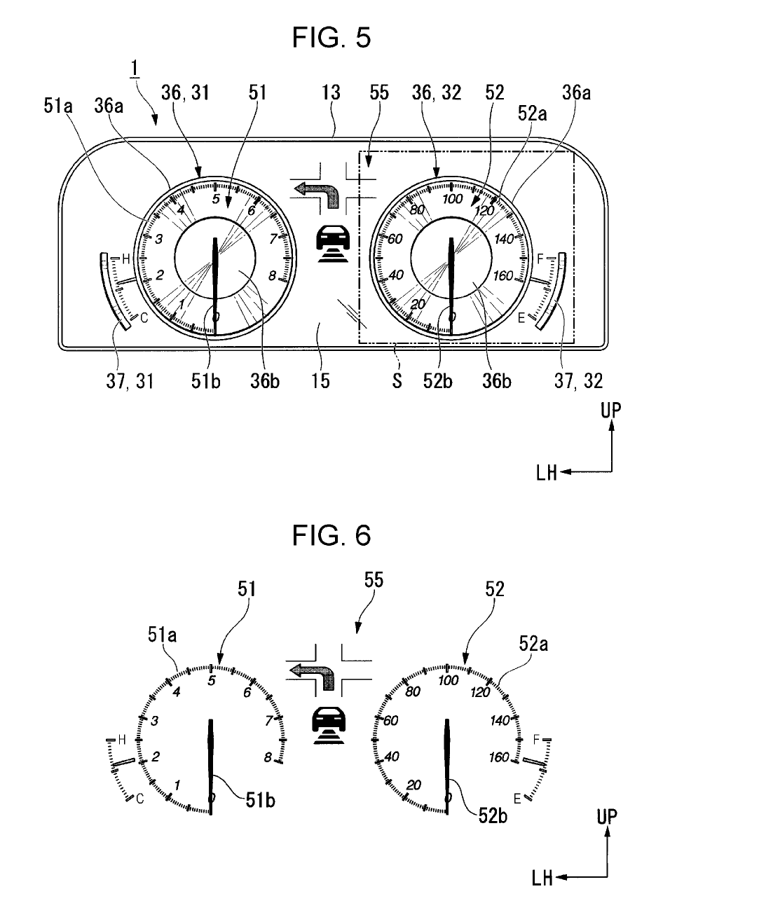

FIG. 5 is a front view illustrating a state of display provided by the vehicle display apparatus 1. FIG. 6 is a front view illustrating virtual images alone that are in the state illustrated in FIG. 5.

The state of display illustrated in FIG. 5 is provided by the vehicle display apparatus 1 in which the left decorative panel 31 and the right decorative panel 32 are in the first state. Specifically, the respective first instrument members 36 of the left decorative panel 31 and the right decorative panel 32 face toward the driver, the left light source 41 and the right light source 42 are on, and the first instrument member 36 of the left decorative panel 31 and the first instrument member 36 of the right decorative panel 32 are visible to the driver. In this state, the virtual-image-generator 20 displays a left gauge image 51, a right gauge image 52, and an information image 55.

As illustrated in FIGS. 5 and 6, the left gauge image 51 in the first state visualized by the image displaying device 21 is displayed in a space between the driver and the left decorative panel 31 and above the half mirror 22 (see FIG. 1). The left gauge image 51 is viewed by the driver as a virtual image as if the left gauge image 51 were on the first instrument member 36 of the left decorative panel 31. The left gauge image 51 is a virtual image of a gauge that indicates the engine speed (hereinafter referred to as “tachometer”). The left gauge image 51 includes a scale image 51a and an indicator image 51b. The scale image 51a of the left gauge image 51 is displayed in such a manner as to conform to the outer circumference of the large-diameter portion 36a of the first instrument member 36 of the left decorative panel 31 and is viewed as a virtual image by the driver. The indicator image 51b of the left gauge image 51 is displayed in such a manner as to extend radially from the center of the small-diameter portion 36b of the first instrument member 36 of the left decorative panel 31 toward the outer side and is viewed as a virtual image by the driver. A combination of the first instrument member 36 of the left decorative panel 31 and the left gauge image 51 that are superposed is viewed as a tachometer by the driver.

The right gauge image 52 in the first state visualized by the image displaying device 21 is displayed in a space between the driver and the right decorative panel 32 and above the half mirror 22 (see FIG. 1). The right gauge image 52 is viewed by the driver as a virtual image as if the right gauge image 52 were on the first instrument member 36 of the right decorative panel 32. The right gauge image 52 is a virtual image of a gauge that indicates the vehicle speed (hereinafter referred to as “speed meter”). The right gauge image 52 includes a scale image 52a and an indicator image 52b. The scale image 52a of the right gauge image 52 is displayed in such a manner as to conform to the outer circumference of the large-diameter portion 36a of the first instrument member 36 of the right decorative panel 32 and is viewed as a virtual image by the driver. The indicator image 52b of the right gauge image 52 is displayed in such a manner as to extend radially from the center of the small-diameter portion 36b of the first instrument member 36 of the right decorative panel 32 toward the outer side and is viewed as a virtual image by the driver. A combination of the first instrument member 36 of the right decorative panel 32 and the right gauge image 52 that are superposed is viewed as a speed meter by the driver.

The information image 55 in the first state visualized by the image displaying device 21 is displayed in a space between the driver and the meter face 15 and above the half mirror 22 (see FIG. 1). In this state, the information image 55 is viewed by the driver as a virtual image as if the information image 55 were on the meter face 15. The information image 55 includes a water-temperature gauge displayed in a left-end area of the meter face 15, a fuel gauge displayed in a right-end area of the meter face 15, and a vehicle-location information displayed in a central area of the meter face 15. The virtual image of the water-temperature gauge is viewed adjacent to the ornamental portion 37 of the left decorative panel 31 that is illuminated by the ornamental-portion light source. Hence, a combination of the ornamental portion 37 of the left decorative panel 31 and the virtual image of the water-temperature gauge included in the information image 55 that are superposed is viewed as an almost real water-temperature gauge by the driver. The virtual image of the fuel gauge is viewed adjacent to the ornamental portion 37 of the right decorative panel 32 that is illuminated by the ornamental-portion light source. Hence, a combination of the ornamental portion 37 of the right decorative panel 32 and the virtual image of the fuel gauge included in the information image 55 that are superposed is viewed as an almost real fuel gauge by the driver.

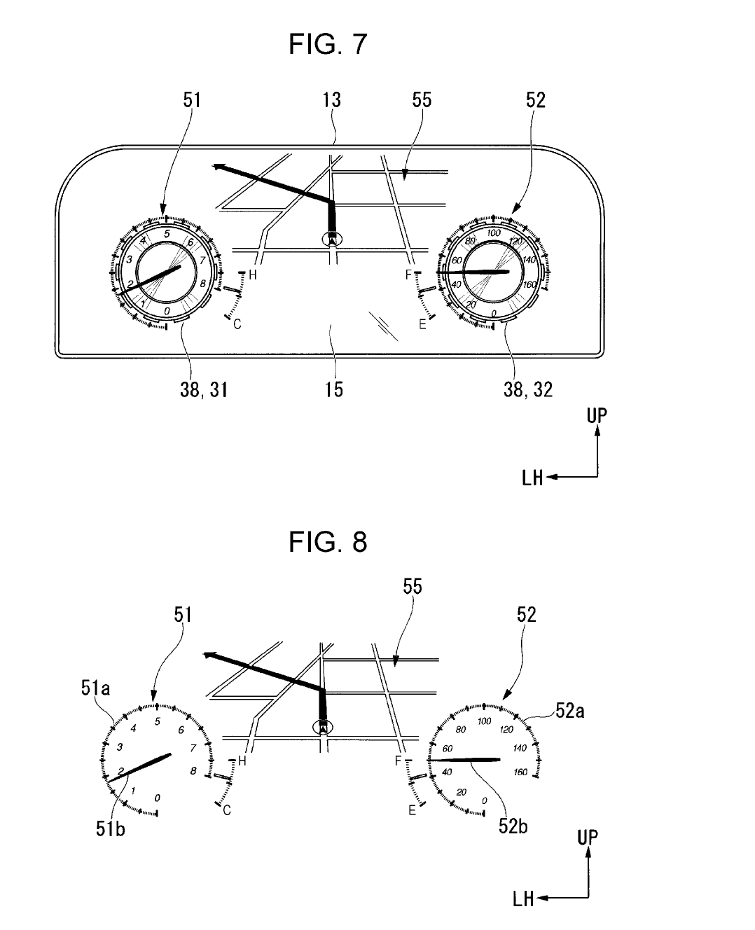

FIG. 7 is a front view illustrating another state of display provided by the vehicle display apparatus 1. FIG. 8 is a front view illustrating virtual images alone that are in the state illustrated in FIG. 7.

The state of display illustrated in FIG. 7 is provided by the vehicle display apparatus 1 in which the left decorative panel 31 and the right decorative panel 32 are in the second state. Specifically, the respective second instrument members 38 of the left decorative panel 31 and the right decorative panel 32 face toward the driver, the left light source 41 and the right light source 42 are on, and the second instrument member 38 of the left decorative panel 31 and the second instrument member 38 of the right decorative panel 32 are visible to the driver. In this state, the virtual-image-generator 20 displays a left gauge image 51, a right gauge image 52, and an information image 55.

As illustrated in FIGS. 7 and 8, the left gauge image 51 in the second state is displayed as a virtual image of a tachometer on the second instrument member 38 of the left decorative panel 31 when seen from the driver. A combination of the second instrument member 38 of the left decorative panel 31 and the left gauge image 51 that are superposed is viewed as a tachometer by the driver. The left gauge image 51 in the second state is displayed in a smaller size than the left gauge image 51 in the first state so as to be fitted to the contour of the second instrument member 38.

The right gauge image 52 in the second state is displayed as a virtual image of a speed meter on the second instrument member 38 of the right decorative panel 32 when seen from the driver. A combination of the second instrument member 38 of the right decorative panel 32 and the right gauge image 52 that are superposed is viewed as a speed meter by the driver. The right gauge image 52 in the second state is displayed in a smaller size than the right gauge image 52 in the first state so as to be fitted to the contour of the second instrument member 38.

The information image 55 in the second state is displayed on the meter face 15 when seen from the driver. The information image 55 includes a water-temperature gauge displayed in an area on the lower right of the left gauge image 51, a fuel gauge displayed in an area on the lower left of the right gauge image 52, and a vehicle-location information displayed in a central area of the meter face 15.

Now, the transition of the state of the decorative panels 30 from the first state to the second state will be described. Since the transition of the state of the left decorative panel 31 and the transition of the state of the right decorative panel 32 are the same, the following description basically concerns the transition of the state of the right decorative panel 32, and description of the transition of the state of the left decorative panel 31 is omitted.

When the rotating mechanism 35 of the vehicle display apparatus 1 rotates the decorative panel 30 about the axis of rotation P so as to change the state of display between the first state and the second state, the light source 40 is turned off. In the vehicle display apparatus 1, the inner surface of the garnish 13 has a lower reflectance than the surfaces of the first and second instrument members 36 and 38 of the decorative panel 30. Furthermore, the lens 17 is positioned in such a manner as to reduce the entrance of external light into the garnish 13. Therefore, when the decorative panel 30 is illuminated by the light source 40, the driver is able to see the first instrument member 36 or the second instrument member 38. In contrast, when the decorative panel 30 is not illuminated by the light source 40, the driver is not able to see either the first instrument member 36 or the second instrument member 38. That is, while one of or both of the left decorative panel 31 and the right decorative panel 32 are changing the states thereof, a corresponding one of or both of the light sources 40 are off. Therefore, the one of or both of the decorative panels 30 that are in transition are not visible to the driver.

When the decorative panel 30 is in the transition from the first state to the second state, the virtual-image-generator 20 displays a process in which the shape of the first instrument member 36 in the first state that is viewed by the driver changes continuously and a process in which the shape of the second instrument member 38 in the second state that is viewed by the driver changes continuously.

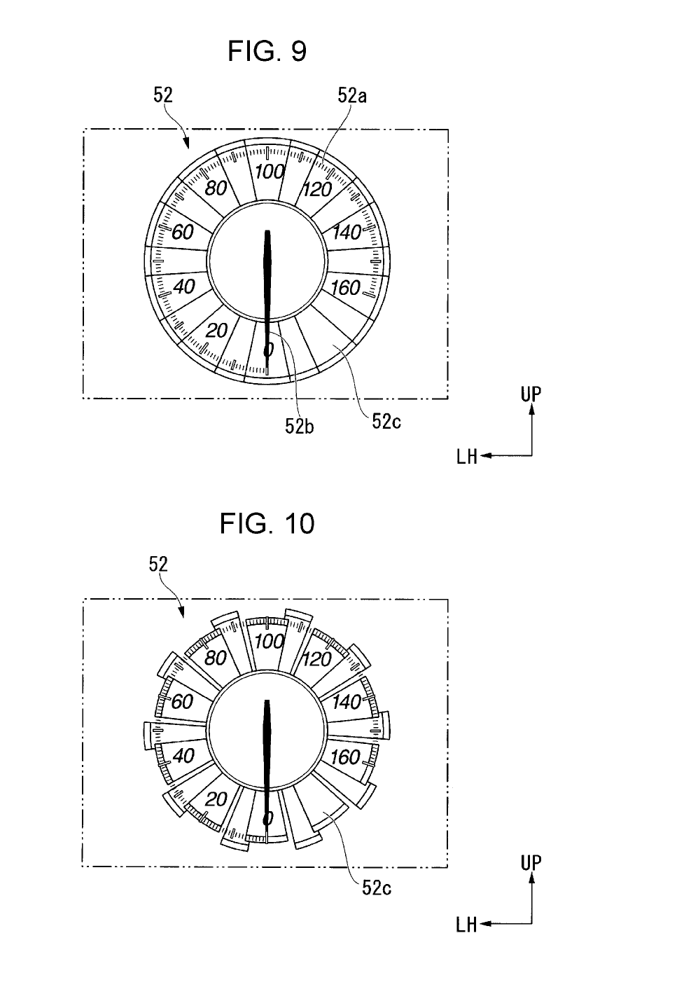

FIGS. 9 to 12 each illustrate a state in the transition of the display provided by the vehicle display apparatus 1 and are each an enlargement of an area S defined in FIG. 5.

When the state of the right decorative panel 32 starts to be changed by the right rotating mechanism 35b from the first state illustrated in FIG. 5 to the second state illustrated in FIG. 7, the right light source 42 is turned off. Hence, the first instrument member 36 of the right decorative panel 32 becomes not visible to the driver. Furthermore, the ornamental-portion light source provided on the outer surface of the first instrument member 36 of the right decorative panel 32 is turned off in conjunction with the right light source 42. Hence, the ornamental portion 37 becomes not visible to the driver. In this state, as illustrated in FIG. 9, the virtual-image-generator 20 of the vehicle display apparatus 1 displays, as the right gauge image 52, not only the scale image 52a and the indicator image 52b illustrated in FIG. 6 but also an instrument-panel image 52c corresponding to the first instrument member 36.

As the transition from the first state to the second state progresses, referring now to FIG. 10, the shape of the instrument-panel image 52c included in the right gauge image 52 is changed continuously. Specifically, a portion of the instrument-panel image 52c that corresponds to the large-diameter portion 36a of the first instrument member 36 is divided into a plurality of segments (twenty segments in the embodiment) in the circumferential direction. Subsequently, every second one of the segments of the instrument-panel image 52c is moved radially inward, so that the segments are staggered alternately.

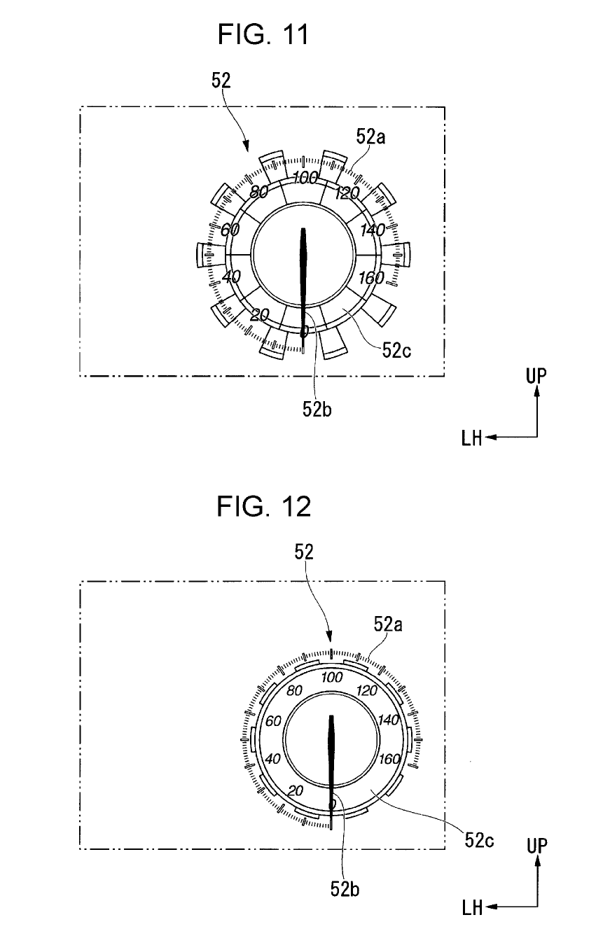

As the transition from the first state to the second state further progresses, referring now to FIG. 11, the right gauge image 52 gradually shrinks and moves toward the lower right in the display area. Specifically, the portion of the instrument-panel image 52c that corresponds to the large-diameter portion 36a and has an alternately staggered shape is deformed such that the diameter of the portion is reduced. Furthermore, a portion of the instrument-panel image 52c that corresponds to the small-diameter portion 36b, the scale image 52a, and the indicator image 52b shrink radially inward and continuously move toward the lower right in the display area. In this process, among the segments of the instrument-panel image 52c that correspond to the large-diameter portion 36a, adjacent ones of the segments that have moved radially inward are joined to each other, whereby the moved segments as a whole come to have a shape corresponding to the large-diameter portion 38a of the second instrument member 38.

Then, immediately before the completion of the transition from the first state to the second state, referring now to FIG. 12, the virtual-image-generator 20 displays, as the right gauge image 52, not only the scale image 52a and the indicator image 52b illustrated in FIG. 8 but also the instrument-panel image 52c corresponding to the second instrument member 38. In this state, the remaining ones of the segments of the portion of the instrument-panel image 52c that correspond to the large-diameter portion 36a and are positioned on the radially outer side come to have respective shapes corresponding to the petal portions 38c (see FIG. 4) of the second instrument member 38.

Lastly, when the transition from the first state to the second state is complete, the virtual-image-generator 20 turns off the instrument-panel image 52c of the right gauge image 52 and the right light source 42 is turned on, whereby the second instrument member 38 of the right decorative panel 32 becomes visible to the driver. Hence, a combination of the second instrument member 38 of the right decorative panel 32 and the right gauge image 52 that are superposed as illustrated in FIG. 7 is viewed by the driver. Thus, the virtual-image-generator 20 of the vehicle display apparatus 1 simulates the transition from the first instrument member 36 to the second instrument member 38. Hence, the driver views the display as if the shape of the instrument member changed continuously.

The transition of the state of the decorative panel 30 from the second state to the first state is implemented by inverting the process of the above transition from the first state to the second state.

As described above, the vehicle display apparatus 1 according to the embodiment includes the decorative panels 30 each provided with a plurality of instrument members (the first instrument member 36 and the second instrument member 38), and the rotating mechanisms 35 that rotate the respective decorative panels 30 about the respective predetermined axes of rotation P and each change which of the plurality of instrument members to be allowed to face toward the driver in the vehicle.

In such a configuration, since the vehicle display apparatus 1 includes the rotating mechanisms 35 that each change which of the plurality of instrument members (the first instrument member 36 and the second instrument member 38) to be allowed to face toward the driver in the vehicle, a plurality of instrument members having different shapes are allowed to be viewed by the driver. Thus, a vehicle display apparatus capable of providing a display with superior design is obtained.

The vehicle display apparatus 1 according to the embodiment further includes the light sources 40 that illuminate the respective decorative panels 30, and the virtual-image-generator 20 that displays virtual images in the space between the driver in the vehicle and the decorative panels 30.

In the vehicle display apparatus 1 having such a configuration, while the instrument members of the decorative panels 30 are made visible to the driver by illuminating the decorative panels 30 with the light sources 40, virtual images can be displayed in any areas by using the virtual-image-generator 20. Hence, the vehicle display apparatus 1 can provide a display with superior design, without losing the textures of the real instrument members, by causing the virtual-image-generator 20 to display virtual images in the space between the driver and the instrument members in such a manner as to superpose the virtual images upon the instrument members.

According to the embodiment, the light sources 40 are each switchable between the on state and the off state.

In such a configuration, the instrument members are made visible to the driver when the light sources 40 are on. Thus, a display that is superior in expressing the textures of the real instrument members is provided. Furthermore, the instrument members of the decorative panels 30 are not visible to the driver when the light sources 40 are off. Therefore, the virtual-image-generator 20 can display virtual images that are free of restrictions imposed by the shapes of the instrument members even in areas where, when seen from the driver, the instrument members of the decorative panels 30 are provided.

According to the embodiment, the decorative panels 30 each include the first instrument member 36 and the second instrument member 38. By rotating the decorative panel 30 about the axis of rotation P, each of the rotating mechanisms 35 alternates the first state where the first instrument member 36 faces toward the driver and the second state where the second instrument member 38 faces toward the driver. The light sources 40 are off during the transition between the first state and the second state. During the transition between the first state and the second state, the virtual-image-generator 20 displays the process in which the shape of the first instrument member 36 in the first state that is viewed by the driver changes continuously and the process in which the shape of the second instrument member 38 in the second state that is viewed by the driver changes continuously.

In such a configuration, since the light sources 40 are off during the transition between the first state where the first instrument member 36 faces toward the driver and the second state where the second instrument member 38 faces toward the driver, the decorative panels 30 that are being rotated are not visible to the driver. While the decorative panels 30 are being rotated, the virtual-image-generator 20 of the vehicle display apparatus 1 displays, as virtual images, the process in which the shape of the first instrument member 36 and the shape of the second instrument member 38 change during the transition. Therefore, the driver views the first instrument member 36 and the second instrument member 38 as if they were changing their shapes continuously. Thus, a display with far superior design is provided.

The present application is not limited to the above embodiment described with reference to the drawings, and various modifications can be made to the embodiment within the technical scope of the present application.

For example, while the above embodiment concerns a case where the information image 55 includes a water-temperature gauge, vehicle-location information, and so forth, the present application is not limited to such a case. The information image 55 may include a single piece of information or a combination of various pieces of information including any other pieces of information as well as those mentioned above, and such pieces of information may be displayed in any areas.

While the above embodiment concerns a case where the scales and the indicators of the speed meter and the tachometer are displayed as the gauge images 51 and 52 that are virtual images, the present application is not limited to such a case. For example, the scales and the indicators of the speed meter and the tachometer may be formed as real objects provided on the first instrument member 36 and the second instrument member 38 of each of the decorative panels 30, and the real objects may be viewed by the driver.

While the above embodiment concerns a case where the left decorative panel 31 and the right decorative panel 32 are arranged in plane symmetry, the present application is not limited to such a case. The left decorative panel 31 and the right decorative panel 32 may have different shapes.

While the above embodiment concerns a case where the decorative panels 31 and 32 each include two instrument members (the first instrument member 36 and the second instrument member 38), the present application is not limited to such a case. The decorative panels 31 and 32 may each include three or more instrument members.

The vehicle display apparatus 1 may have a function of detecting the position where the driver is seated. With such a function, even if the driver has changed his/her position, the vehicle display apparatus 1 can display relevant gauge images and information images at more appropriate positions, providing a high-quality display.

In addition, any of the elements employed in the above embodiment may be replaced with any known elements equivalent thereto, without departing from the scope of the present application.

What is claimed is:

1. A vehicle display apparatus comprising:
a decorative panel provided with a plurality of instrument members for showing vehicle conditions to a driver in a vehicle, the decorative panel having a first side and a second side, each of the first and second sides having at least one of the plurality of instrument members, one of the first and second sides being placed to face toward the driver; and
a rotating mechanism configured to rotate the decorative panel about a predetermined axis of rotation in a manner that changes said one of the first and second sides to the other to be the side facing toward the driver.

2. The vehicle display apparatus according to claim 1, further comprising:
a light source that illuminates the decorative panel; and
a virtual-image-generator that displays a virtual image in a space between the driver in the vehicle and the decorative, in which the virtual image is superimposed on an image regarding the vehicle conditions generated from the decorative panel.

3. The vehicle display apparatus according to claim 2, wherein the light source is switchable between an on state and an off state.

4. The vehicle display apparatus according to claim 3,
wherein the decorative panel has a first instrument member and a second instrument member,
wherein the rotating mechanism rotates the decorative panel to alternate a first state where the first instrument member faces toward the driver and a second state where the second instrument member faces toward the driver via a transition state between the first state and the second state,
wherein the light source is off during the transition state, and
wherein, during the transition state, the virtual-image-generator displays a plurality of different virtual images in such order that the plurality of different virtual images constitute step-by-step changes from a shape of the first instrument member in the first state to a shape of the second instrument member in the second state in a manner that allows the driver to view the changes as continuous changes.
